(19) United States
(12) Patent Application Publication
(10) Pub. No.: US 2006/0086720 A1
(43) Pub. Date: Apr. 27, 2006

(54) Image heating apparatus

(75) Inventors: Takahiro Nakase, Toride-shi (JP); Hitoshi Suzuki, Matsudo-shi (JP); Naoyuki Yamamoto, Toride-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/254,718

(22) Filed: Oct. 21, 2005

(30) Foreign Application Priority Data
Oct. 22, 2004 (JP) 308336/2004(PAT.)

(51) Int. Cl. H05B 6/14

(52) U.S. Cl. 219/619

(57) ABSTRACT

In a fixation apparatus using induction heating, a cooling sequence is performed, after an output of a magnetic flux generation member is terminated, to quickly effect cooling of an induction coil when needed without disposing a particular member.

### FIELD OF THE INVENTION AND RELATED ART

The present invention relates to an image heating apparatus for heating an image on a recording material. As the image heating apparatus, there are a fixation apparatus for fixing a unfixed image on the recording material, a gloss-imparting apparatus for improving a gloss of an image by heating the image fixed on the recording material.

FIG. 2 is a schematic sectional view of an electrophotographic apparatus. In the electro-photographic apparatus, a photosensitive drum 1 is electrically charged by a charging apparatus 2 and an original or data are converted into light L by an original-supporting plate or a laser scanner. The photosensitive drum is exposed to the light L, so that an electric potential is lowered at an exposed portion, thus being different from that an unexposed portion. Depending on this difference in electric potential, a manner of jumping of toner t in a developing apparatus to the photosensitive drum 1 varies, so that an image is formed. The resultant toner image formed on the photosensitive drum is transferred onto a recording material P by a transfer apparatus 5. At this time, toner remaining on the photosensitive drum 1 without being transferred is recovered by a cleaning apparatus 6. Further, the recording material P onto which the toner image is transferred is conveyed to a fixing apparatus 7 by which the toner image is fixed.

FIG. 3 is a schematic sectional view of a conventional fixing apparatus usable in the electrophotographic apparatus. The fixing apparatus 7 includes a fixation roller 8 for melting the toner t on the recording material P and a pressure roller 9 for pressing the recording material P against the fixation roller 9. The fixation roller 8 is formed in a hollow shape and is provided with a halogen lamp at the inside thereof. A predetermined voltage is applied to the halogen lamp to generate heat.

However, in the case of using the halogen lamp as a heat source, radiation heat from the halogen lamp is utilized, so that a considerable time is required for warming up and an energy efficiency is not high.

In recent years, with respect to the heating apparatus, realization of compatibility between energy saving (low power consumption) and improvement in usability (quick print performance) has further received attention and has become importance.

As an apparatus for realizing such compatibility, an induction heating-type heating apparatus utilizing high-frequency induction as a heating source has been proposed (e.g., Japanese Laid-Open Patent Application (JP-A) Sho 59-33787). In this induction heating-type heating apparatus, a coil is concentrically disposed inside a hollow fixation roller formed o a metal conductor and is supplied with a high-frequency current to generate a high-frequency magnetic field, whereby an induction eddy current is generated on the fixation roller to cause the fixation roller per se to generate Joule heat by a skin resistance of the fixation roller itself. According to the induction heating-type heating apparatus, an electrothermal conversion efficiency is considerably improved, so that it becomes possible to reduce a warm-up time. However, in such a heating apparatus of the induction heating-type, a large current of several amperes to several ten amperes passes through the induction coil, so that the heating apparatus has been accompanied with a temperature rise problem due to the Joule heating of the induction coil itself. Further, in the case where the induction coil is disposed in an inner space of a heating member, efficient heat dissipation cannot be effected to increase a degree of temperature rise of the induction coil.

In the case where such a temperature rise of the induction coil is caused to occur, e.g., three has arisen such a problem that a coating of the induction coil is melted by heat to lose insulating properties.

For this reason, in order to suppress the temperature rise of the induction coil, such a proposal that a heat dissipation plate for releasing heat from the induction coil is disposed has been made (e.g., JP-A Sho 54-39645). Further, such a proposal that a heat dissipation plate is disposed in contact with the induction coil in order to suppress the temperature rise of the induction coil has also been proposed (e.g., JP-A Hei 09-16006).

In the induction heating-type heating apparatus proposed in JP-A Sho 59-33787, however, a cooling mechanism is operated while adjusting a temperature of an induction heating member by using the cooling mechanism such as air blowing. For this reason, in an actual operation, the cooling is performed while effecting heating which is contradictory to the cooling, thus failing to save energy. Further, there is also such a problem that a resultant cooling effect is low. In addition, it is necessary to newly provide the cooling mechanism, thus resulting in an increase in cost.

Further, in JP-A Sho 54-39645, heat dissipation is also performed during the warming up which is not required to dissipate heat by the heat dissipation plate, so that the warm-up time is prolonged to increase an amount of power consumption during fixation standby when compared with the case where the heat dissipation plate is not disposed.

### SUMMARY OF THE INVENTION

An object of the present invention is to provide an image heating apparatus capable of cooling a coil by a simple constitution.

According to an aspect of the present invention, there is provided an image heating apparatus, comprising:

a heat rotation member for heating an image on a recording material;

an induction coil for causing the heat rotation member to generate heat by induction heating;

control means for controlling a temperature of the heat rotation member by regulating energization of the induction coil; and

execution means for executing a cooling operation for the induction coil, when the induction coil is increased in temperature beyond a predetermined level by the energization of the induction coil despite the temperature of the heat rotation member being normal, by stopping an image heating operation and rotating the heat rotation member.

According to another aspect of the present invention, there is provided an image heating apparatus, comprising:

a heat rotation member for heating an image on a recording material;

an induction coil for causing the heat rotation member to generate heat by induction heating;

control means for controlling a temperature of the heat rotation member by regulating energization of the induction coil;

temperature detection means for detecting a temperature of the induction coil; and

execution means for executing a cooling operation for the induction coil, when the detected temperature of the induction coil reaches a predetermined temperature.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a time chart schematically showing a cooling sequence.

FIG. 2 is a schematic sectional view of an electrophotographic apparatus.

FIG. 3 is a schematic sectional view of a conventional fixation apparatus.

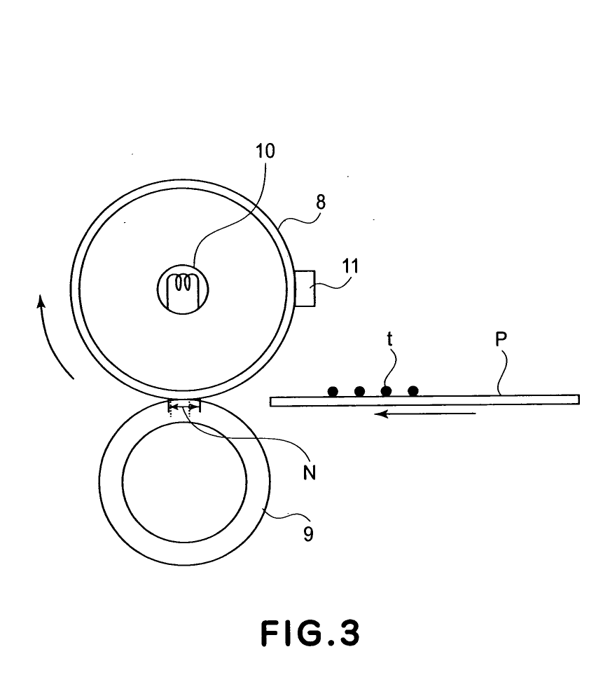

FIG. 4 is a schematic sectional view of an induction heating apparatus according to Embodiment 1.

FIG. 5 is a time chart showing a temperature rise of an induction coil used in Embodiment 1.

FIG. 6 is a time chart schematically showing a conventional cooling sequence.

FIG. 7 is a time chart schematically showing a cooling sequence in Embodiment 1.

FIG. 8 is a time chart in the case where a fixation roller is not rotated in Embodiment 1.

FIG. 9 is a time chart schematically showing a cooling sequence in Embodiment 3.

FIG. 10 is a time chart schematically showing a cooling sequence in Embodiment 5.

FIGS. 11(a) and 11(b) are schematic views each showing a magnetic flux shielding means in Embodiment 6.

FIG. 12 is a flow chart schematically showing a cooling operation.

### DETAILED DESCRIPTION OF THE PREFERRED EMBODIMENTS

### Embodiment 1

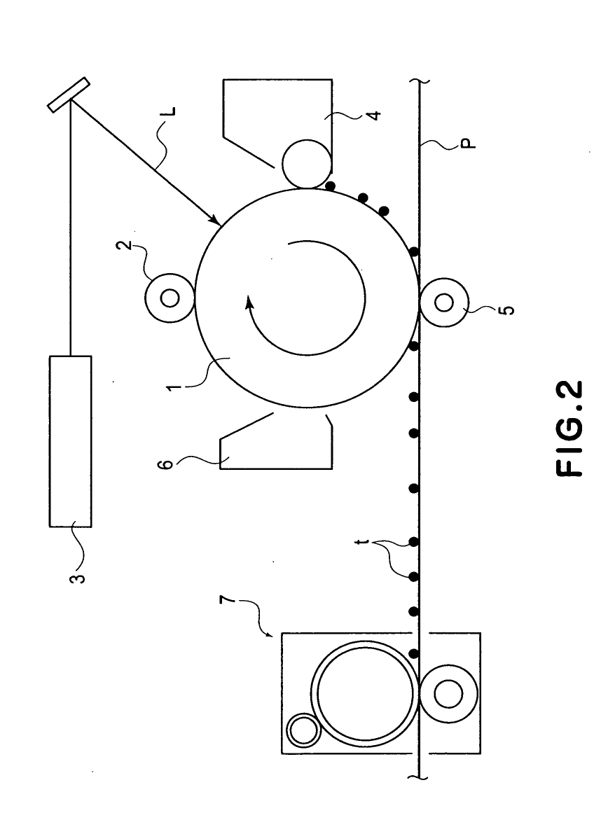

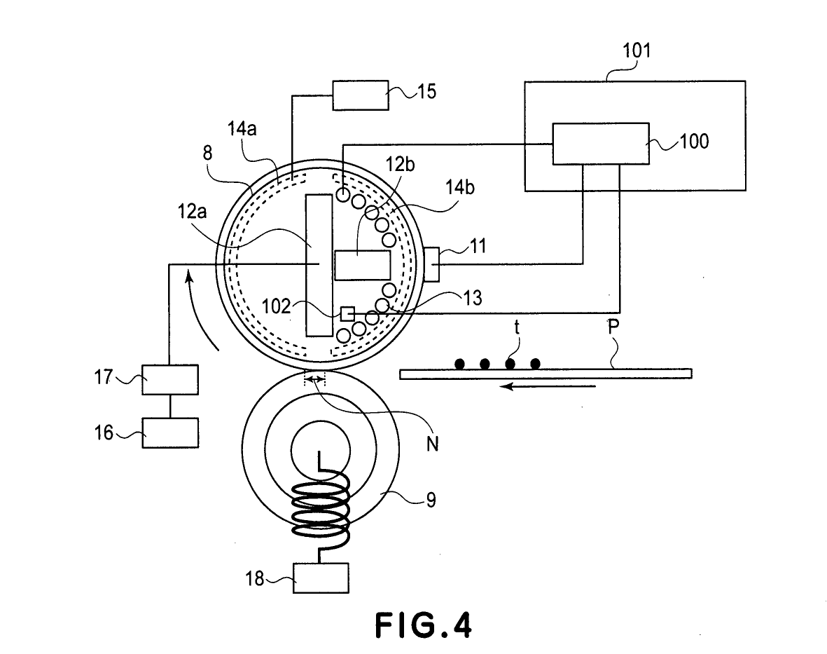

FIG. 4 is a schematic sectional view of an induction heating apparatus in this embodiment of the present invention. Incidentally, a constitution of an electrophotographic apparatus including the induction heating apparatus as a fixation apparatus is the same as that described above with reference to FIG. 2 except that the constitution of the fixation apparatus is different, thus being omitted from specific explanation.

Referring to FIG. 4, a fixation roller 8 as a heat rotation member which generates heat by electromagnetic induction comprises an iron-made core metal cylinder having an outer diameter of 40 mm, a thickness of 0.7 mm, and a length of 340 mm and a surface layer of a fluorine-containing resin, such as PFA or PTFE, for improving a surface releasability. In order to obtain a high-quality fixation image such as a color image, between the core metal cylinder and the surface layer, it is also possible to dispose a heat-resistant elastic layer of silicone rubber or the like.

A pressure roller 9 as a nip forming member is constituted by a hollow core metal having an outer diameter of 35 mm, a thickness of 3 mm, and a length of 340 mm, and a heat insulating layer which is formed as a heat-resistant rubber layer having a surface releasability at a peripheral surface of the core metal.

The fixation roller 8 and the pressure roller 9 are rotatably supported and pressed against each other by an unshown pressure mechanism, thus forming a fixation nip N having a width of about 5 mm. The fixation roller 8 is driven at a speed of 300 mm/sec by an unshown rotation motor, and the pressure roller 9 is rotated by a frictional force with the fixation roller 8 at the fixation nip N. A recording sheet P is introduced in the fixation nip N while carrying thereon unfixed toner image t, and the toner image t is heated under pressure to become a fixed image.

An induction coil 13 is held by a core 12 (12a, 12b) in an unshown holder formed of a heat-resistant magnetic resin, such as PPS, PEEK, phenolic resin, etc., and by a stay (not shown). To the induction coil 13, an AC current of 10-100 kHz is applied, whereby an eddy current is generated at an inner surface, which is an electroconductive layer, of the fixation roller 8 by a magnetic field induced by the AC current, thus generating Joule heat. At this time, the induction coil per se also generates heat by an internal resistance thereof.

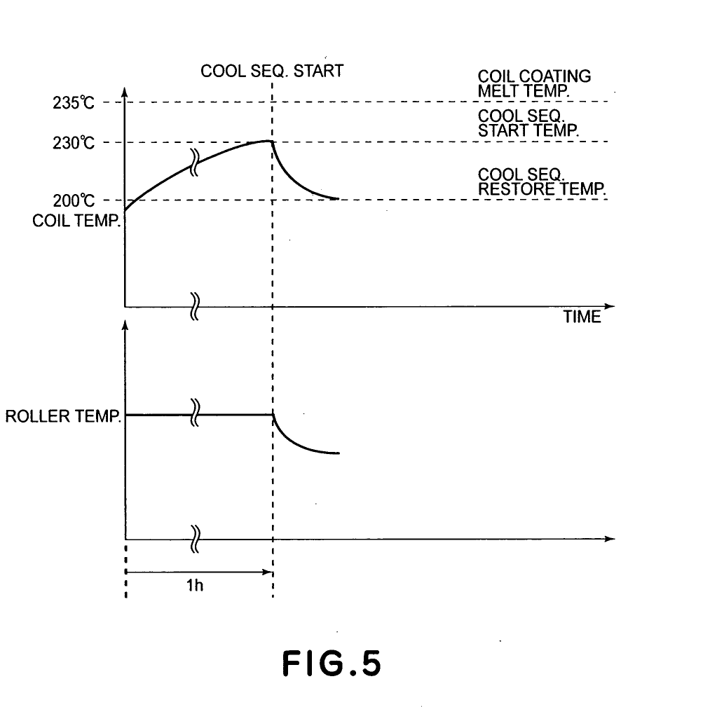

Now, assuming that a temperature-controlled state in which a surface temperature of the fixation roller is kept at a normal fixing temperature of 200° C. by a temperature detection means 11 when paper having a A4 size which is a maximum width of plain paper in an axial direction of the fixation roller is continuously passed through the fixation nip is continued for 1 hour, this state is such a state that the temperature of the induction coil in the fixation roller at its central portion is predicted that it reaches 230° C. on the basis of previous study as shown in FIG. 5. A coating resin of the induction coil is formed of a material which is melted at 235° C., so that there is a possibility that the induction coil becomes electrically shorted.

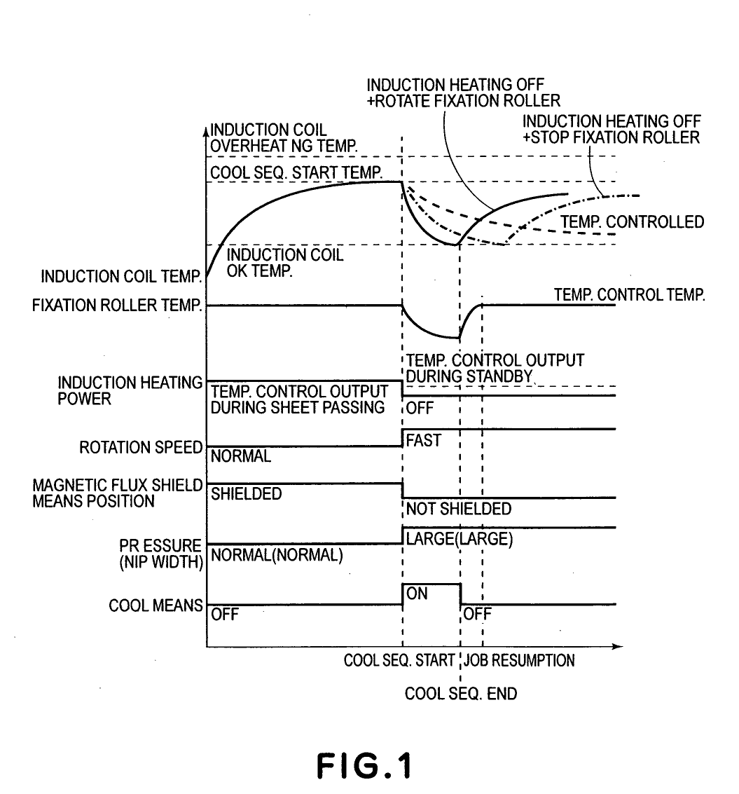

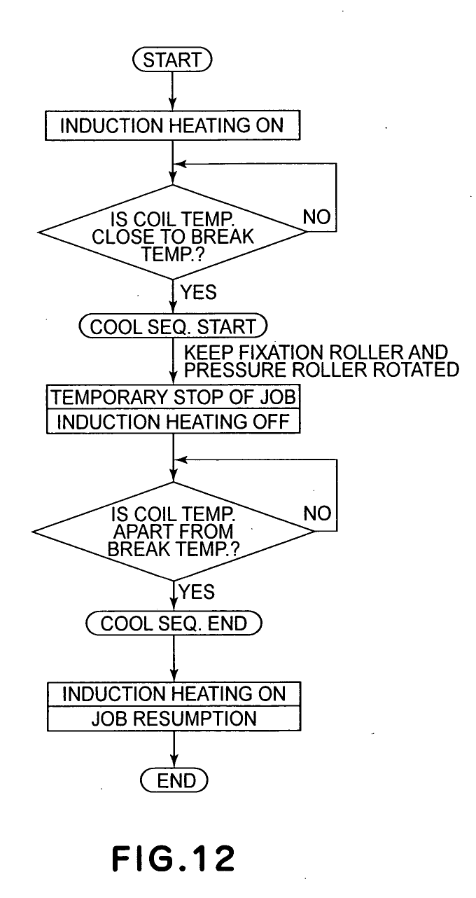

For this reason, in the present invention, in the case where such a temperature rise of the induction coil is caused to occur although the temperature of the fixation roller is kept at a normal fixing temperature, an image forming job is interrupted and a cooling sequence of the induction coil as shown in FIG. 12 is executed. Incidentally, FIG. 1 is a time-line chart showing progressions of a induction coil temperature and a fixation roller temperature with time in a pre-stage of the cooling sequence, in an execution stage of the cooling sequence, and after completion of the cooling sequence. FIG. 1 also shows progressions of energization of the induction coil a rotation speed of the fixation roller, a position of a magnetic flux shielding plate, a nip pressure between the fixation roller and the pressure roller, and the cooling sequence.

In the cooling sequence, when the temperature of the induction coil reaches 230° C. (predetermined temperature) (or is predicted that it reaches 230° C.), the image forming job is temporarily stopped and power supply to the induction coil by a control apparatus (energization control means) 100 is turned off. In this state, the cooling sequence is started by rotating the fixation roller 8 and the pressure roller 9 by using a rotation control means 16.

In the cooling sequence, the power supply to the induction coil is turned off, so that there is no heat generation due to the internal resistance of the induction coil. Further, by idle rotation of the fixation roller, a high-temperature ambient air between the fixation roller and the induction coil is dissipated outside the fixation roller.

Further, the fixation roller is rotated at idle in contact with the pressure roller, so that the heat of the fixation roller is also released into the pressure roller. This is because the pressure roller is not provided with a heat source, thus having a lower temperature. Further, by the idle rotation of the fixation roller, the heat is also released into ambient air. As described above, the cooling sequence has two cooling functions.

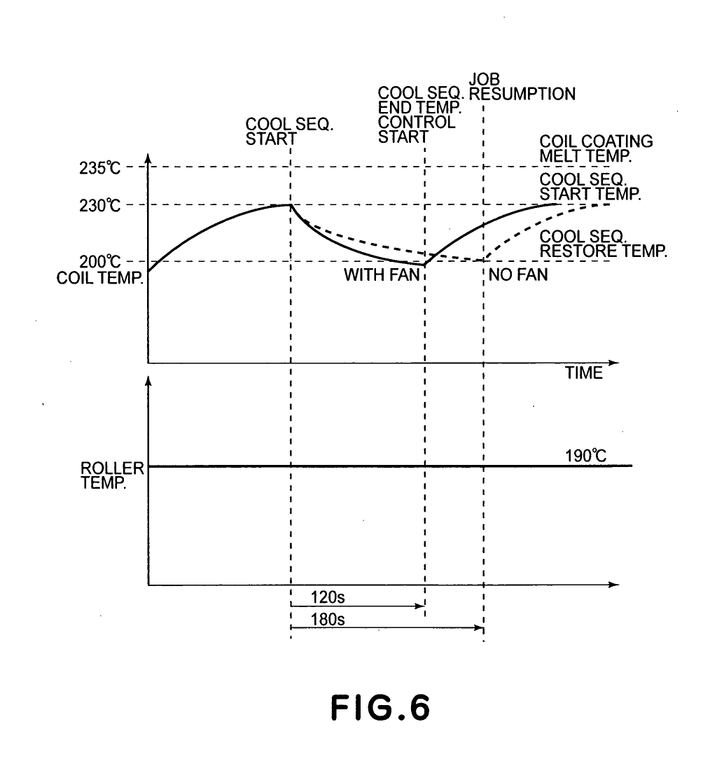

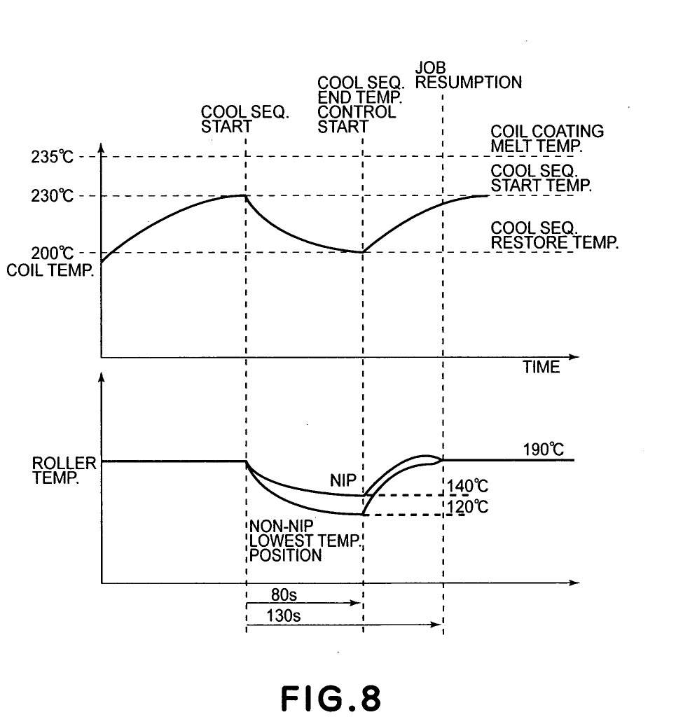

By the above described cooling sequence, the induction coil temperature is lowered to a restore set temperature of 200° C. A time required to resume the sheet passing operation was about 180 sec as shown in FIG. 6 in the case where both of the fixation roller and the pressure roller are rotated while temperature-controlling the fixation roller so as to be kept at a certain temperature by a conventional temperature detection means 11. Further, in the case of using a fan, the time was 120 sec. When the induction heating is stopped without rotating the fixation roller, as shown in FIG. 8, the induction coil temperature is gradually lowered but an irregularity in temperature particularly between the fixation nip portion and another (non-nip) portion (e.g., at a lowest temperature position) is caused to occur, so that irregularities in fixability and gloss are caused to occur if left uncontrolled. Further, the fixation roller is not rotated, so that an amount of heat released into air is also decreased. For this reason, the above described time which also including a time required for removal of the irregularities is 130 sec for resumption of the sheet passing operation. Here, the induction coil temperature is measured by disposing a thermocouple in the neighborhood of the induction coil.

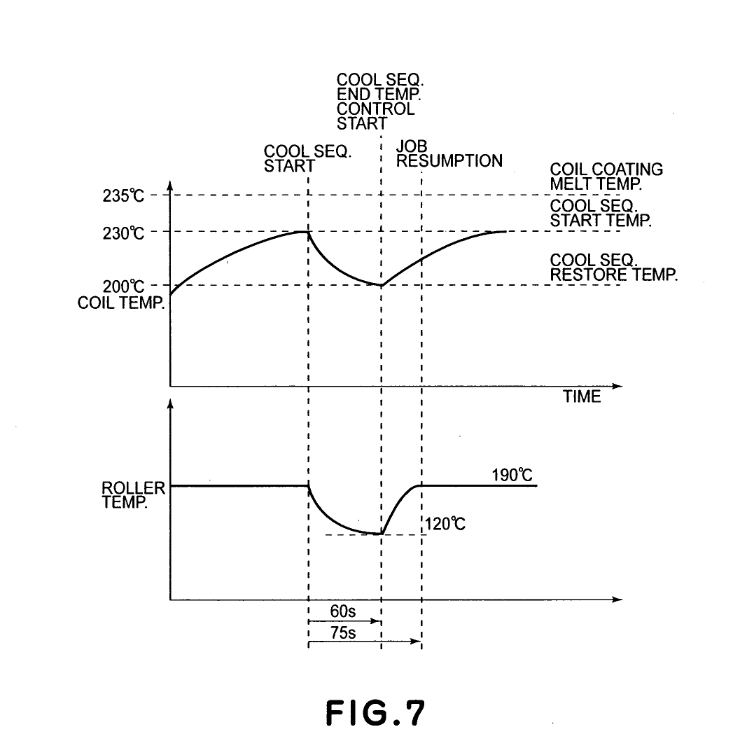

Compared with the above described conventional cooling sequence, in the cooling sequence in the present invention, as shown in FIG. 7, the time for the resumption is 75 sec without using a particular cooling mechanism. In the case of using a fan in combination, it is possible to resume the sheet passing operation (image forming operation) in 30 sec.

In this embodiment, the temperature of induction coil is predicted by the temperature detection means of the fixation roller and the continuous energization time of the induction coil but may also be predicted by other conditions or be directly detected to performed the cooling sequence. Incidentally, the continuous energization time is measured by a timer provided in the control apparatus.

The continuous energization time of the induction coil refers to a time period during which energization of the induction coil is continued when a plurality of recording sheets are continuously subjected to image formation. Incidentally, in such a constitution that the energization of the induction coil is on-off controlled depending on a detected temperature of the fixation roller, counting of the energization time is not stopped by “energization off” but is continued as it is.

### Embodiment 2

In this embodiment, a basic constitution is the same as in Embodiment 1 except that the fixation apparatus further includes a magnetic flux shielding means which can be disposed between the induction coil and the fixation roller to shield generated magnetic flux at both end portions of the fixation roller in its axial direction. More specifically, as shown in FIG. 4, by a magnetic flux shielding means drive means 15, the magnetic flux shielding means is moved, in a circumferential direction of the fixation roller, to a position 14b as needed and a position 14a if it is not required.

Now, when a sheet passing operation job of B5-sized paper which has a smaller size in a longitudinal direction of the fixation roller is selected by a user, the magnetic flux shielding means is disposed between the induction coil and the fixation roller as a heat generation member at the longitudinal end portions of the fixation roller. As a result, the fixation roller does not substantially generate heat at the both end portions thereof. WIth respect to the induction coil, an effective length of the fixation roller is decreased, so that an electrical resistance of the fixation roller is lowered, thus reducing a power factor. Accordingly, due to a reduced heat conversion efficiency, in the case where the surface of the fixation roller is used and temperature-controlled at the same temperature, the induction coil is liable to be increased in temperature by disposing the magnetic flux shielding means between the induction coil and the fixation roller.

After a lapse of 5 minutes from the start of magnetic flux shielding, the temperature of the induction coil reaches 230° C. on the basis of previous study, so that the cooling sequence is performed to cool the induction coil and then the job is resumed. The job is completed without causing melting of the coating layer of the induction coil.

### Embodiment 3

In this embodiment, a basic constitution is the same as in Embodiment 1 except that the fixation roller is rotationally driven at a speed of 200 mm/sec. In the case where thin paper having a smaller thickness than plain paper is used, the induction coil temperature is saturated at 220° C., so that the constitution in this embodiment does not require the cooling sequence.

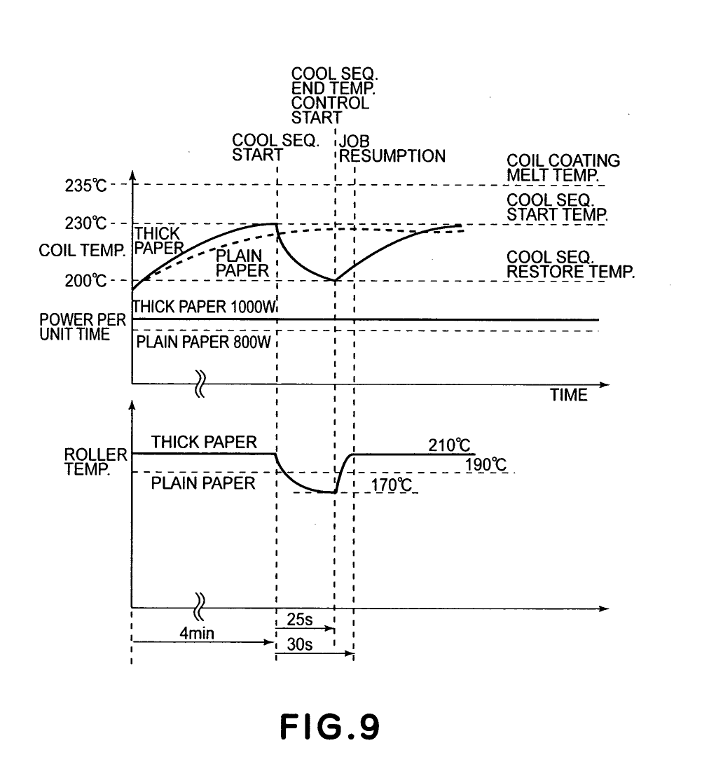

Now, when a sheet passing operation job of thick paper thicker than plain paper is selected by a user, as shown in FIG. 9, a fixation temperature of the fixation roller is set to 210° C. in order to ensure a fixability of the thick paper. Further, the thick paper has a heat capacity larger than the plain paper. For these two reasons, a power supplied to the induction coil during the job of the thick paper is increased compared with the case of the job of the plain paper, so that the induction coil is liable to be increased in temperature.

According to previous study, the induction coil temperature reaches 230° C. after a lapse of 4 minutes from the start of the job of the thick paper. Accordingly, the image forming job is interrupted after 4 minutes from the start of the job of the thick paper and the cooling sequence is performed. After the induction coil is cooled by the cooling sequence, the image forming job is resumed. As a result, the image forming job was capable of being completed to the end without causing melting of the coating resin of the induction coil.

### Embodiment 4

In this embodiment, a basic constitution is the same as Embodiment 1 except that the fixation roller has three rotation speeds including a speed (V1) of 300 mm/s during an ordinary white/black job, a speed (V2) of 75 mm/s during a full-color job, and a speed (V3) of 50 mm/s for suppressing heat dissipation in standby state during the sheet passing operation, and that a pressure of the fixation roller with respect to the pressure roller can be changed into three levels including no pressure (P0) for decreasing a start-up time of the fixation roller, a pressure (P1) for the plain paper job, and a pressure (P2) for meeting a job of a recording material on which it is difficult to fix a toner image. These pressures satisfy the following relationships: P0<P1<P2. In this case, corresponding nip widths are 1 mm, 5 mm and 7 mm, respectively.

Now, the selected job is the full-color job for plain paper and the fixation roller is set to have the rotation speed (V2) and the pressure (P1). Under these conditions, the fixation roller is placed, during the sheet passing operation, in such a state that the induction coil temperature reaches 230° C. for some reason. In this state, the rotation speed of the fixation roller is changed to the fastest rotation speed (V1) and as shown in FIG. 1, the pressure of the fixation roller is changed to the largest pressure (P2) at the nip width of 7 mm to perform the cooling sequence. As described above, an amount of heat released into air and the pressure roller is increased by increasing the rotation speed of the fixation roller and the amount of heat released into the pressure roller is further increased by increasing the nip width, so that the time required for resumption of the job was capable of being described from 40 sec under the conditions of V2 and P1 to 25 sec under the conditions of V1 and P2.

### Embodiment 5

In this embodiment, a basic constitution is the same as in Embodiment 2 except that the position of the magnetic flux shielding means is changed.

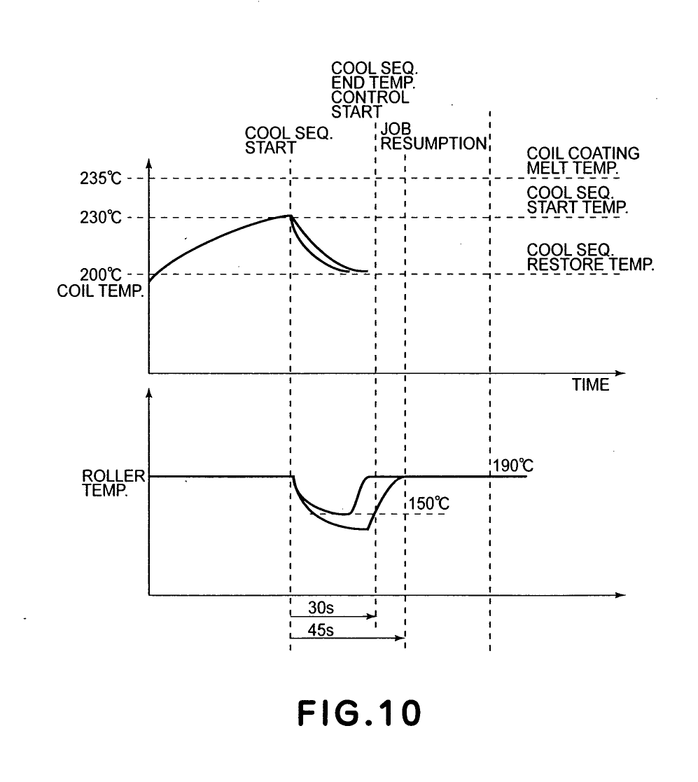

More specifically, a job of a small-sized paper is selected and as shown in FIG. 10, the fixation roller is placed in such a state that the induction coil temperature reaches 230° C. when the magnetic flux shielding (adjusting) means is located at the position 14b. In this case, the magnetic flux shielding means is spaced apart from the induction coil and moved to the position 14a and at the same time, the cooling sequence is performed. The magnetic flux shielding means per se is also increased in temperature, so that the time required to resume the job is decreased from 35 sec at the position 14b to 30 sec at the position 14a because an amount of heat released into the induction coil can be reduced by moving the magnetic flux shielding means to the position 14a.

Alternatively, a time period during which the magnetic flux shielding (adjusting) means is located at the magnetic flux shielding position is counted by a CPU 101 and the induction coil temperature is judged that it reaches a predetermined temperature when the time period exceeds a predetermined time period. When this judgement is made, the cooling sequence may be performed.

### Embodiment 6

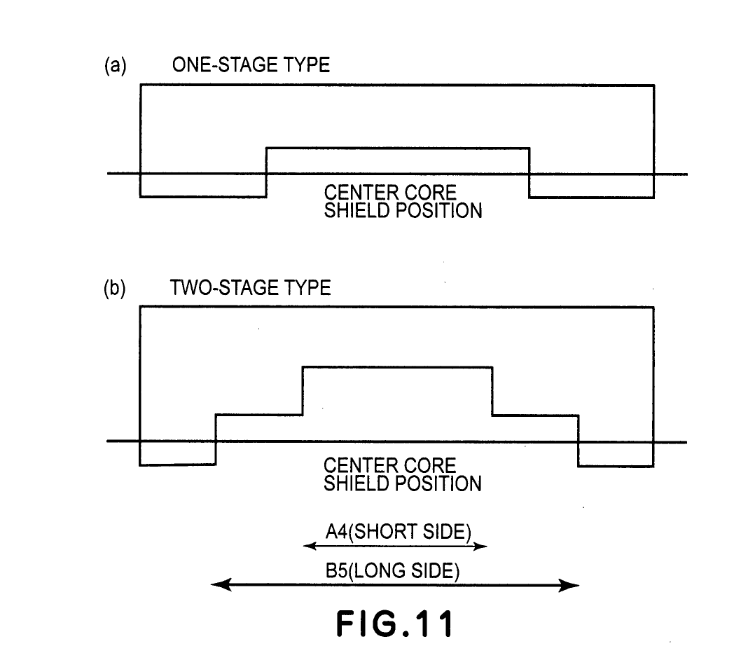

In this embodiment, a basic constitution is the same as in Embodiment 2 except that the shape of the magnetic flux shielding means is changed to those shown in FIGS. 11(a) and 11(b). More specifically, the magnetic flux shielding means is designed so that it can shield magnetic flux at both end portions thereof at two stages in order to meet papers of various sizes.

Now, a job of O5-sized paper is selected by a user. In the case where the magnetic flux shielding means is a one-stage shielding plate (member) for shielding the magnetic flux over a length corresponding to an intermediary length between those of A4 (short side) and B5 (long side), temperature rise at end portions of the fixation roller is caused to occur at non-sheet passing portion. For this reason, the magnetic flux shielding means is required to be disposed at the magnetic flux shielding position. In this case, when the magnetic flux shielding is effected, end portions of the B5-sized paper in the axial direction is rather less liable to generate heat. As a result, it is difficult to effect fixation at the non-heating area. In addition, the magnetic flux is excessively shielded, so that the temperature rise of the induction coil is more liable to occur. However, when a two-stage shielding plate (member) which meets the respective sized papers of A4 (short side) and B5 (long side) as shown in FIG. 11(b) is used, a coil center core 12b shown in FIG. 4 is shielded at a position shown in FIG. 11(b). As a result, magnetic flux at only a necessary portion can be shielded, so that the temperature rise of the induction coil can be considerably suppressed. Accordingly, the number of execution of the cooling sequence can be decreased. More specifically, with respect to type one-stage shielding plate, the number of execution of the cooling sequence is 4 in a job for 1000 sheets. On the other hand, with respect to the two-stage shielding plate, the number of execution of the cooling sequence is decreased to 2, so that the job for 1000 sheets was capable of being completed about 1 minute higher than the case of the one-stage shielding plate.

As described hereinabove, according to the present invention, it is possible to efficiently effect cooling of the induction coil with a simple constitution.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 308336/2004 filed Oct. 22, 2004, which is hereby incorporated by reference.

What is claimed is:

1. An image heating apparatus, comprising:
a heat rotation member for heating an image on a recording material;
an induction coil for causing said heat rotation member to generate heat by induction heating;
control means for controlling a temperature of said heat rotation member by regulating energization of said induction coil; and
execution means for executing a cooling operation for said induction coil, when said induction coil is increased in temperature beyond a predetermined level by the energization of said induction coil despite the temperature of said heat rotation member being normal, by stopping an image heating operation and rotating said heat rotation member.

2. An apparatus according to claim 1, wherein said execution means executes the cooling operation when a continuous energization time of said induction coil is a predetermined time.

3. An apparatus according to claim 1, said apparatus further comprises magnetic flux adjusting member for adjusting magnetic flux, generated from said induction coil, acting on said heat rotation member; and said execution means executes the cooling operation when a time of continuous presence of said magnetic flux adjusting member at a magnetic flux adjusting position is a predetermined time.

4. An apparatus according to claim 3, wherein said execution means executes the cooling operation in a state in which said magnetic flux adjusting member is moved from the magnetic flux adjusting position to a position spaced apart from the magnetic flux adjusting position.

5. An apparatus according to claim 1, wherein said apparatus further comprises a nip forming member for forming a heat nip between said nip forming member and said heat rotation member, and a width of the heat nip during the cooling operation is longer than that during an ordinary image heat treatment.

6. An apparatus according to claim 1, wherein said apparatus further comprises a nip forming member for forming a heat nip between said nip forming member and said heat rotation member, and a pressure of the heat nip during the cooling operation is larger than that during an ordinary image heat treatment.

7. An apparatus according to claim 1, wherein said induction coil is disposed inside said heat rotation member.

8. An image heating apparatus, comprising:
a heat rotation member for heating an image on a recording material;
an induction coil for causing said heat rotation member to generate heat by induction heating;
control means for controlling a temperature of said heat rotation member by regulating energization of said induction coil;
temperature detection means for detecting a temperature of said induction coil; and
execution means for executing a cooling operation for said induction coil, when the detected temperature of said induction coil reaches a predetermined temperature.

9. An apparatus according to claim 8, wherein said execution means executes the cooling operation for said induction coil despite the temperature of said heat rotation member being normal by stopping an image heating operation.
